(19) United States
(12) Patent Application Publication
(10) Pub. No.: US 2024/0358183 A1
(43) Pub. Date: Oct. 31, 2024

(54) Multipurpose capsule coffee pot

(71) Applicants: Zhejiang Jintao Electric Co.,Ltd, Jinhua (CN); Jinhua Deren Trading Co., LTD, Jinhua (CN)

(72) Inventors: Zhiguo Ying, Jinhua (CN); Tao Liu, Jinhua (CN); Chen Chen, Jinhua (CN)

(21) Appl. No.: 18/768,470

(22) Filed: Jul. 10, 2024

(51) Int. Cl. A47J 31/44; A47J 31/54

(52) U.S. Cl. CPC A47J 31/4403; A47J 31/54

(57) ABSTRACT

The invention provides a multi-purpose capsule coffee pot, including the upper body and a coffee bucket, the upper body is provided with a capsule cartridge, the side of the top of the capsule box is provided with an extraction valve assembly, the bottom of the capsule valve assembly with an upper needle, the bottom of the coffee capsule, the capsule cushion, the boiler assembly at the bottom of the upper body, the boiler assembly with a protective sleeve, the bottom of the protective sleeve with a support grid, the bottom of the supporting grille is provided with a sealed flat gasket. The invention provides a multi-purpose capsule coffee pot, the capsule box combined with the body, without the influence of coffee capacity and taste to reduce the volume, easy to carry, subvert the structure design of the traditional capsule coffee machine, can use coffee capsule.

### TECHNICAL FIELD

The invention relates to the field of coffee making equipment, in particular to a multi-purpose capsule coffee pot.

### BACKGROUND TECHNOLOGY

Coffee pot as a kind of coffee appliance, in daily life by many people, as people on the pursuit of quality of life, used to make coffee powder has a lot of use, including direct add simple coffee powder, convenient to use various shapes of coffee powder capsules, or make coffee powder easy package, different coffee powder use, use coffee production equipment is different, need to use different types of coffee pot, or different types of coffee machine to make coffee.

Making coffee on the market now use mocha coffee pot, brewing coffee pot, hand pressure coffee pot, drip type coffee machine, Italian pressure coffee machine, capsule coffee machine, can only use a single type of coffee or coffee capsule, so for consumption of green, poor compatibility, each coffee preparation use conditions are different, technically difficult to meet the needs of making different kinds of coffee.

Therefore, it is necessary to provide a multi-purpose capsule coffee pot to solve the aforementioned technical problems.

### INVENTION CONTENT

The present invention provides a multi-purpose capsule coffee pot, which solves the problem of the single function of a coffee pot.

In order to solve the above technical problems, the present invention provides a multi-purpose capsule coffee pot, comprising:
The upper body and coffee powder bucket, the upper body is provided with a capsule box, the side of the top of the capsule box is provided with an extraction valve assembly, the bottom of the extraction valve assembly is provided with a needle, the capsule box is provided with a coffee capsule, the bottom of the capsule box is provided with a capsule gasket;
Boiler assembly, the boiler assembly is provided below the upper pot body, the boiler assembly is provided with a protective cover, the bottom of the protective sleeve is provided with a support grid, and the bottom of the support grid is provided with a sealing flat pad;
The suction pipe connection end, the suction pipe connection end is provided below the support grille, the suction pipe connection end is provided between the support grille and the protective sleeve, and the lower end of the suction pipe connection end is provided with the suction pipe;
The seat, the seat is provided at the bottom of the boiler assembly, a bottom cover under the base, and an upper coupler inside;
Base, the base is provided below the connection seat, the base surface is connected with a lower coupler, one side of the base has a base cover, and one side of the base has a power switch.

Preferably, the extraction valve assembly includes a valve seat, the right and left sides of the valve seat, the top is provided with a pressure cover, the surface of the pressure cover is provided with a spring, and the surface sleeve of the valve seat is provided with a valve cover.

Preferably, the top of the upper body is provided and the center of the surface is connected with covered beads.

Preferably, one side of the upper pot body surface is connected with a handle, the bottom of the boiler assembly is provided with a fixing screw B, and the internal fixing screw B is provided with a sealing ring C.

Preferably, the surface of the boiler assembly has a connection thread B, and the inner wall of the bottom of the upper lid has a connection thread A.

Preferably, the coffee bucket is provided with a bucket cover, and the boiler assembly is provided with a boiler assembly edge.

Preferably, the surface of the capsule cartridge is provided with a block, the surface of the block is provided with a plurality of fixed screw holes A, the surface of the capsule cartridge is provided with an O-sealing ring, and the upper body is provided with a groove compatible with the capsule block.

Preferably, the bottom of the boiler assembly is provided and the bottom plate is provided with laser welding.

Preferably, a pressure relief valve is installed on the side of the boiler assembly surface, a temperature controller inside the inner seat, and a fuse at the center of the inner wall of the seat.

Preferably, the bottom of the base, the storage assembly includes a mounting seat, a ring storage slot at the bottom of the receiving base, the sides of the ring receiving tank wall, the surface of the ring bump is bonded with a slip pad, the left and right sides of the bottom of the mounting base are connected with a suction cup, and a rotating member is provided between the mounting base and the base.

Compared with the related techniques, a multi-purpose capsule coffee pot provided by the present invention has the following beneficial effects:

The invention provides a multi-purpose capsule coffee pot, the capsule combined with the box and the volume and without the influence of coffee capacity and taste reduced the volume, simplify the structure, easy to carry, subvert the structure design of the traditional capsule coffee machine, can use coffee capsules, or using coffee powder directly to prepare coffee.

The two bottom plate schemes make the coffee pot can be used in indoor electricity, but also can be used in gas furnace, alcohol furnace, carbon fire, electric furnace and other fire sources, to adapt to the use of different environments, really achieve the purpose of multi-purpose.

On the pot body and capsule box two parts combination, capsule box through bottom shape block embedded on the bottom of the pot body shape groove, through the screw fixed together, this kind of structure on the premise of the capsule box, pot body according to the market needs can use different materials such as metal, plastic, glass, ceramics, material manufacturing molding, but also facilitate the appearance of the pot body innovation design.

Upper pot body and boiler assembly by connecting thread A, Connection thread B screw tight connection, Coffee capsules are placed in the capsule container, The lower needle pierced the plane of the coffee capsule, The upper needle pierced the bottom of the coffee capsule, So that the high temperature water steam into the coffee capsule for boiling, When the water vapor temperature reaches 119° C., The saturated steam pressure reaches 2 Bar, When the extraction coffee pressure reaches the set value, Coffee liquid top spring controlled spool, Remove the spool from the sealing surface, Get the coffee liquid into the extraction valve assembly under pressure, Coffee liquid from the overflow hole with the optimized pressure flow ratio into the upper pot, So as to obtain high-quality oil, fine and mellow coffee.

Boiler assembly edge is equipped with support grid, support grid is the active structure, can be removed from the boiler assembly, at the lower end of the support grid end with the capsule gasket, when the capsule sealing role, need to unload, the body on the capsule gasket can effectively protect the tip of the needle without scratching the operator.

### ATTACHED FIGURE DESCRIPTION

FIG. 1 is a schematic view of the first embodiment of a multi-purpose capsule coffee pot;

FIG. 2 shows the schematic diagram of the first scheme;

FIG. 3 shows the structure diagram of the second scheme;

FIG. 4 is the schematic diagram of the boiler assembly structure;

FIG. 5 shows a schematic diagram of the structure of the upper pot body;

FIG. 6 shows the schematic diagram of the circuit control;

FIG. 7 is a schematic diagram of the second embodiment of a multi-purpose capsule coffee pot provided by the present invention.

1. On the pot body, 2. Capsule volume cartridge, 3. Coffee capsules, 4, on the pot lid, 5. The cover bead, 6. Handle, 7. Extraction valve assembly, 8. Seat, 9. Sool, 10. Protective cover, 11. Spring, 12. The valve cover, 13, the overflow hole, 14. Infusion tube connecting thread, 15, the needle, 16, the O-shaped sealing ring, 17. Seal the flat gasket, 18, capsule sealing ket, 19, the block, 20, the groove, 21. fixing the screw hole A, 22. The connecting thread, A, Powder bucket cover, Coffee powder bucket, 25, supporting the grid, 26, the lower prick needle, 27. The connecting thread, B, 28, water suction pipe, 29. Connecting end of water suction pipe, 30, the boiler assembly, Pressure relief valve, Water steam, 33. Fixed the screw hole B1, 34, Seal ring C, 35, Fuses, 36. Temperature controller, 37. Connecting seat, 38, the upper coupler, 39, the bottom cover, 40, the base, 41. Base cover, 42, Lower coupler, 43. Power supply plug line, 44. Power supply switch, 45. fixing the screw hole B, Fire source, 47. Base plate, 48, Laser welding, 49, Press the cover, 50. Eedge of boiler assembly

51, storage components, 511, 511, installation seat, 512, 513, 513, ring bump, 514, skid pad, 515, suction cup, 516, rotating parts.

### SPECIFIC IMPLEMENTATION METHODS

The present invention is further explained below in combination with the accompanying drawings and the embodiments.

### First Embodiment

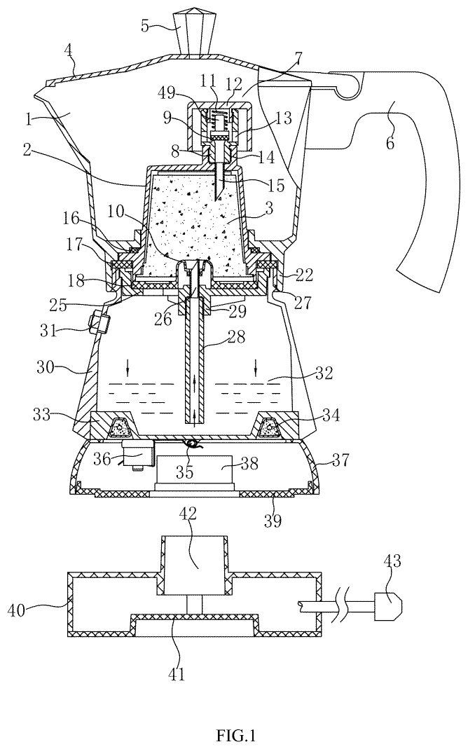

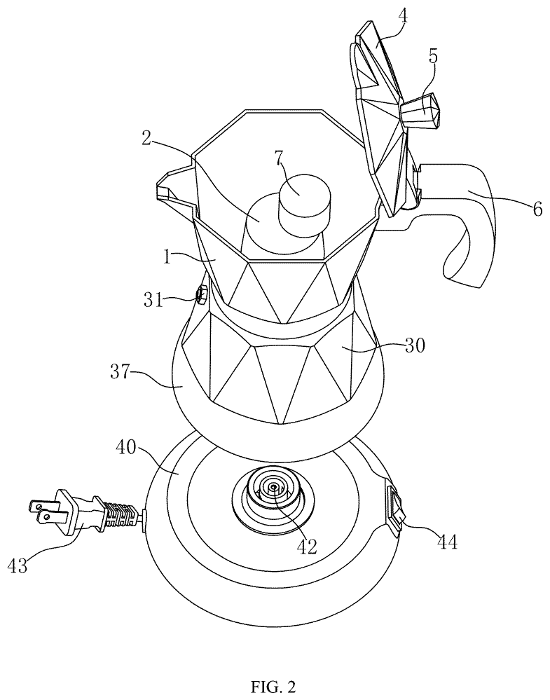

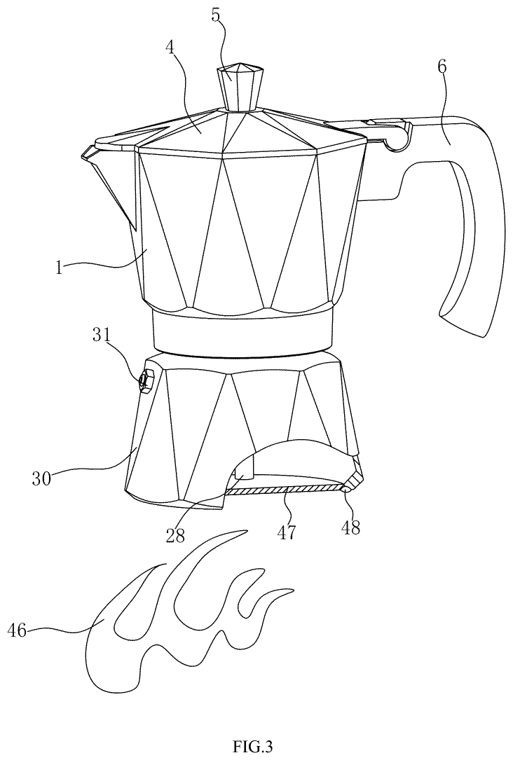

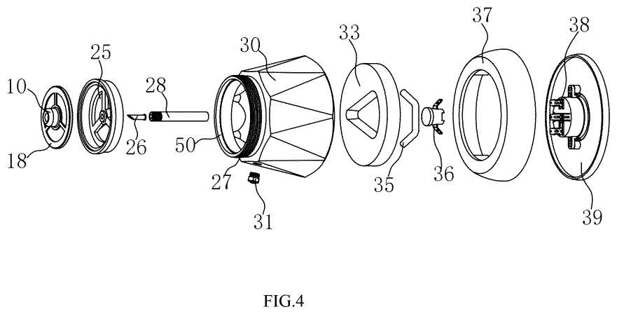

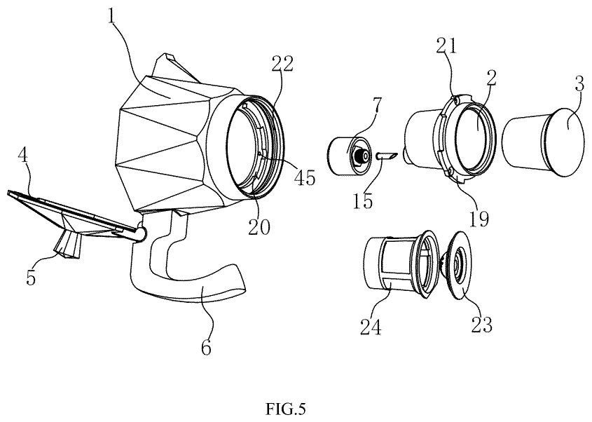

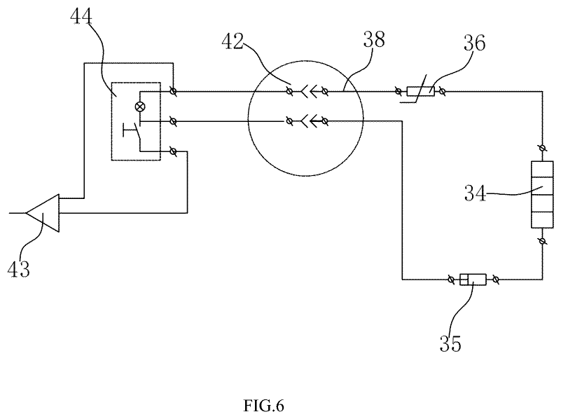

Refer to FIGS. 1,2,3,4,5 and 6, FIG. 1 is the structural diagram of the first embodiment of a multi-purpose capsule coffee pot provided with the present invention; FIG. 2 is the structure of the first scheme; FIG. 3 is the structure of the second scheme; FIG. 4 is the boiler assembly structure; FIG. 5 shows the structure of the upper pot body, and FIG. 6 is the schematic diagram of the circuit control.

A multi-purpose capsule coffee pot, including:
The upper pot body 1 and the coffee powder bucket 24, the upper pot body 1 is provided with the capsule container 2, the top of the capsule container 2 is provided with the extraction valve assembly 7, the bottom of the extraction valve assembly 7 is provided with the top needle 15, the capsule container 2 is provided with the coffee capsule 3, the bottom of the capsule container 2 is provided with the capsule cushion 18;
The boiler assembly 30, the boiler assembly 30 is provided below the upper pot body 1, the boiler assembly 30 is provided with a shield 10, the bottom of the protective sleeve 10 is provided with a support grid 25, and the bottom of the support grid 25 is provided with a sealing flat pad 17;
The suction pipe connection end 29, the suction pipe connection end 29 is provided below the support grille 25, the suction pipe connection end 29 is provided between the connection end 29 and the support grille 25 and the protective cover 10 with the lower needle 26, the lower end of the suction pipe connection end 29 is provided with the suction pipe 28;
Connect seat 37, the connection seat 37 is provided at the bottom of the boiler assembly 30, the connection seat 37 is provided with the bottom cover 39, the connection seat 37 is provided with an upper coupler 38;
The base 40, the base 40 is provided below the connection base 37, the center position of the base 40 is connected with a lower coupler 42, the base 40 is provided on one side of the base 40 with a base cover 41 and a base 40 with a power switch 44.

The extraction valve assembly 7 includes a valve seat 8, which is provided with a valve cell 9, the surface and left and right sides of the valve cell 9, the valve cell 9 is provided on top with a pressure cover 49, the pressure cover 49 is provided with a spring 11, and the surface sleeve of the valve seat 8 is provided with a valve cover 12.

The top of the upper lid body 1 is provided with the upper lid 4, and the center of the surface of the upper lid 4 is connected with the lid bead 5.

One side of the surface of the upper pot body 1 is connected with a handle 6, the bottom of the boiler assembly 30 is provided with a fixing screw B1, and the fixing screw B1 is provided with a sealing ring C.

The connection thread B27 is provided on the surface of the boiler assembly 30, and the inner wall at the bottom of the upper lid 1 has the connection thread A22.

The coffee bucket 24 is provided with the powder cover 23, and the boiler assembly 30 is provided with the boiler assembly edge 50.

The surface of the capsule cartridge 2 is provided with a block 19, the surface of the capsule block 19 has a plurality of fixed screw holes A21, the surface of the capsule cartridge 2 is provided with an O-shaped ring 16, and the interior of the upper body 1 has a slot 20 adapted to the capsule block 19.

The boiler assembly 30 is provided at the bottom of the bottom plate 47, and the bottom plate 47 is provided with laser welding 48.

A pressure relief valve 31 is installed on one side of the surface of the boiler assembly 30, a temperature controller 36 is installed on one side of the interior of the connecting seat 37, and a fuse 35 is installed at the center of the inner wall of the connecting seat 37.

As shown in FIGS. 1 and 2, a multi-purpose capsule coffee pot described in the utility model includes upper pot body 1, upper pot lid 4, capsule holding box 2, extraction valve assembly 7, boiler assembly 30, water suction pipe 28, heating plate 33, connection seat 37, and base 40.

As shown in FIGS. 1 and 5, the upper part of the multi-purpose capsule coffee pot described in the utility model is the upper pot body 1, the upper lid 4 and the lid bead 5, and the upper lid 4 covers the upper pot body 1 to prevent the coffee liquid from splashing out.

A capsule cartridge 2 is provided in the upper body 1, an extraction valve assembly 7 is provided at the upper end of the capsule box 2, consisting of valve seat 8, valve core 9, spring 11, valve cover 12 and lid 49, and a sealed flat pad 17 is provided at the lower edge of the capsule box 2.

When use, put the coffee capsule 3 into the capsule container 2, puncture the protective layer of the coffee capsule 3 through the upper needle 15 in the capsule cartridge 2, and ensure that the coffee liquid enters the extraction valve assembly 7 under the action of high pressure steam.

As shown in FIG. 5, the capsule holding box 2 and the upper pot body 1 are a combined structure, placing the capsule holding box 2 at the bottom of the upper pot body 1, placing the O-shaped sealing ring 16, and at the same time align the shaped block 19 on the capsule holding box 2 to the shaped groove 20 of the upper pot body 1, and align the fixed screw hole A 21 on the bottom surface of the capsule holding box 2 with the upper pot body 1, inserting the screw into a whole.

A handle 6 is provided on the side of the upper pot body 1 for hand holding and rotation, the upper end of the upper lid 4 is provided with a cover bead 5 for opening the upper lid 4 for dumping coffee liquid, and at the bottom of the upper pot body 1 is a connection thread A22 for connecting with the upper end connection thread B 27 of the boiler assembly 30.

As shown in FIGS. 1 and 4, the lower portion of the multi-purpose capsule coffee pot described in the utility model consists of boiler assembly 30, support grid 25, capsule gasket 18, suction pipe 28, heating plate 33, connection seat 37, and bottom cover 39.

The upper boiler assembly port edge 50 of the boiler assembly 30 is provided with a support grid 25, The supporting grid 25 adopts an independent structure, Can be placed into the boiler assembly of 30, The support grid 25 is provided with a lower needle 26, Also provided with a capsule gasket 18, A protective cover 10 is provided in the middle of the capsule gasket 18, Protective case 10 can cover the needle 26, Prevent lower needle 26 from scratching the operator, The plane of the capsule gasket 18 is laid against the plane of the coffee capsule 3, Can act as a seal, Prevent water vapor 32 leakage at the support grid 25, Boiler assembly 30 is provided with pressure relief valve 31, To release the pressure when the pressure is too high.

The bottom of the support grid 25 is provided with a water suction pipe connection end 29, which can be connected with the water suction pipe 28. A heating plate 33 is provided at the bottom of the boiler assembly 30, an electric heating tube 34, a temperature controller 36, a bottom cover 39 and an upper coupler 38 at the bottom of the heating plate 33, which can be inserted with the lower coupler 42 on the base 40.

As shown in FIGS. 1,2 and 6, the first scheme of the utility model is as follows, a base 40 is provided at the bottom of the boiler assembly 30, a lower coupler 42 is provided in the middle of the base 40, and a power plug line 43 and a power switch 44 are provided on both sides of the base 40.

The boiler assembly 30 plugs the power supply by the upper coupler 38 and the lower coupler 38 on the seat 37, effectively forming a heating control circuit system, which can realize the function of completing coffee preparation with one click.

As shown in FIG. 1 and FIG. 3, the second scheme of a multi-purpose capsule coffee pot described in the utility model is as follows. At the bottom of the metal boiler assembly 30, it can be firmly integrated with the boiler assembly 30 by laser welding 48. This structure is suitable for gas furnace, alcohol furnace, carbon fire and so on as a heating fire source 46, which is convenient to carry outdoors and easy to use.

As shown in Figure FIG. 11, A multi-purpose capsule coffee pot described in the utility model, Place the coffee capsule 3 into the capsule box 2, Pierce the coffee capsule 3 by stabbing a needle 15, Then pour the pure water from the top end of the boiler assembly 30, Then put the support grid 25 into the boiler assembly opening edge 50, Place the capsule gasket 18 into the support grid 25, Finally, rotate the connection thread A 22 of the upper pot body 1 and the connection thread B27 of the boiler assembly 30 to the tight contact, At this time, the lower prick needle 26 in the middle of the supporting grid 25 pierced the bottom surface of the coffee capsule 3, And tighten the sealing surface of the capsule gasket 18 to obtain a seal, At the same time, the upper end surface of the boiler assembly 30 and the bottom end surface of the upper pot body 1 are sealed through the sealing flat gasket 17, Avoid leaks at the connection.

According to the first or second scheme of the present embodiment, the boiler assembly 30 may be heated to generate water steam 32, When the pure water in the boiler assembly 30 is heated to a saturated steam temperature, It creates a steam pressure, At this time, the steam 32 is along the suction pipe 28, Through the lower prick needle 26 into the coffee capsule 3, The coffee powder in the coffee capsule 3 is boiled in the water steam 32 to form the coffee liquid, Coffee coffee enters seat 28 along the upper needle 15, When the steam pressure of the water steam 32 reaches 2 Bar and exceeds the set value of the spring 11, Coffee liquid top opening valve core 9, Ejection from the overflow hole 13 on the side of seat 8, Coffee solution due to the control of the valve cover 12, Controlled for the liquid splash range, Thus a cup of rich and mellow coffee production is finished.

As shown in FIG. 5, the utility model is a multi-purpose capsule coffee pot that can not only make coffee from coffee capsule 3, but also fill the coffee powder bucket 24 into various flavors of coffee powder and cover the powder bucket cover 23 as a spare coffee capsule to meet the user's choice of different forms of coffee powder.

Compared with the related techniques, a multi-purpose capsule coffee pot provided by the present invention has the following beneficial effects:

The invention provides a multi-purpose capsule coffee pot, the capsule volume box 2 and the pot body 1, under the premise of not affecting the coffee capacity and taste reduced volume, simplify the structure, easy to carry, subvert the structure of the traditional capsule coffee machine, can use the coffee capsule 3, or can use the coffee powder bucket 24 directly with coffee powder to prepare coffee.

The two bottom plate schemes make the coffee pot can be used in indoor electricity, but also can be used in gas furnace, alcohol furnace, carbon fire, electric furnace and other fire sources, to adapt to the use of different environments, really achieve the purpose of multi-purpose.

On the pot body 1 and capsule capacity box 2 two parts combination connection, capsule capacity box 2 through the bottom of shape block 19 embedded on the shape groove 20, by screw fixed together, this structure for the capsule capacity box 2 under the premise of constant, according to the market needs can use different materials such as metal, plastic, glass, ceramics, but also facilitate the appearance of the pot body 1 innovation design.

Upper pot body 1 and boiler assembly 30 by connecting thread A22, Connecting thread B27 rotary connection, Coffee capsule 3 is placed in the capsule container box 2, Lower needle 26 pierced the plane of coffee capsule 3, The needle 15 pierced the bottom of the coffee capsule 3, So that the high temperature water steam into the coffee capsule 3 for boiling, When the water vapor temperature reaches 119° C., The saturated steam pressure reaches 2 Bar, When the extraction coffee pressure reaches the set value, The ool 9 controlled by the coffee liquid opening spring 11, causes the core 9 to remove the sealing surface, Get the coffee liquid into the extraction valve assembly 7 under pressure, Coffee liquid rotates from the overflow hole of the optimized design pressure flow ratio on the valve seat 8 into the upper pot body 1, So as to obtain high-quality oil, fine and mellow coffee.

The boiler assembly 30 is provided with a support grid 25, the support grid 25 is an movable structure, which can be removed from the boiler assembly 30, a water suction pipe 28 at the lower end of the support grid 25 and a capsule cushion 18 when the support grid 25 is placed in the capsule container 2, the capsule gasket 18 seals and the protective case 10 on the capsule gasket 18 can effectively protect the needle tip of the needle needle 26 from scratching the operator.

### Second Embodiment

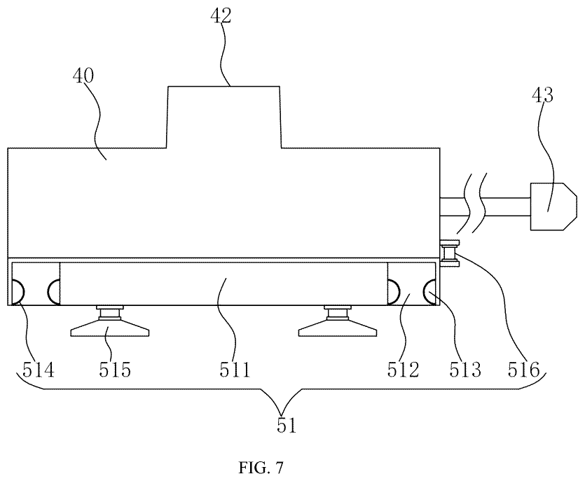

Referring to FIG. 7, based on one multi-purpose capsule coffee pot provided in the first embodiment of the present application, another one is proposed in the second embodiment of the present application. The second embodiment is only a preferred mode of the first embodiment, and the implementation of the second embodiment will not affect the separate implementation of the first embodiment.

concrete, A multipurpose capsule coffee pot provided by the second embodiment of the present application differs in that, A multi-purpose capsule coffee pot, The base 40 is provided at the bottom with a storage assembly 51, The receiving assembly 51 comprises a mounting seat 511, The mounting seat 511 is provided at the bottom of an annular storage slot 512, The two sides of the inner wall of the annular receiving groove 512 are connected with an annular bump 513, The surface adhesion of the annular bump 513 has a non-slip pad 514, The mounting seats 511 are connected to the bottom sides of the suction cup 515, A rotating member 516 is provided between the mounting seat 511 and the base 40.

The mounting seat 511 is connected to the bottom of the base 40, and the annular bump 513 with the non-slip pad 514 may play a fixed role on the power plug line 43.

The present invention provides a multi-purpose capsule coffee pot with the following working principle:
In use, when the power supply plug line 43 is wound, the power supply plug line 43 is wrapped in the ring storage slot 512 and then the power supply plug line 43 is secured through the ring bump 513 with the non-slip pad 514.

Compared with the related techniques, a multi-purpose capsule coffee pot provided by the present invention has the following beneficial effects:
The present invention provides a multi-purpose capsule coffee pot in which the storage assembly 51 is provided at the bottom of the base 40 to wrap the power plug line 43.

The above is only the embodiments of the invention and do not thus limit the patent scope of the invention. All the equivalent structure or equivalent process transformations made by the description of the invention and the contents of the drawings, or directly or indirectly applied in other relevant technical fields, are similarly included in the scope of patent protection of the invention.

What is claimed is:

1. A multi-purpose capsule coffee pot characterized by:
The upper body and coffee powder bucket, the upper body is provided with a capsule box, the side of the top of the capsule box is provided with an extraction valve assembly, the bottom of the extraction valve assembly is provided with a needle, the capsule box is provided with a coffee capsule, the bottom of the capsule box is provided with a capsule gasket;
Boiler assembly, the boiler assembly is provided below the upper pot body, the boiler assembly is provided with a protective cover, the bottom of the protective sleeve is provided with a support grid, and the bottom of the support grid is provided with a sealing flat pad;
The suction pipe connection end, the suction pipe connection end is provided below the support grille, the suction pipe connection end is provided between the support grille and the protective sleeve, and the lower end of the suction pipe connection end is provided with the suction pipe;
The seat, the seat is provided at the bottom of the boiler assembly, a bottom cover under the base, and an upper coupler inside;
Base, the base is provided below the connection seat, the base surface is connected with a lower coupler, one side of the base has a base cover, and one side of the base has a power switch.

2. The multi-purpose capsule coffee pot according to claim 1, wherein the extraction valve assembly comprises a valve seat, a seat set with a valve core, the right and left sides of the seat, the top set with a pressure cover, the surface set with a spring, and the surface cover of the seat is provided with a valve cover.

3. The multi-purpose capsule coffee pot according to claim 1, wherein the top of the upper lid body is provided with an upper lid, and the center of the upper lid surface is connected with a cover bead.

4. The multi-purpose capsule coffee pot according to claim 1, wherein one side of the upper pot body surface is connected with a handle, the bottom of the boiler assembly is provided with a fixing screw B, and the fixing screw B is provided with a sealing ring C.

5. The multi-purpose capsule coffee pot according to claim 1, wherein the surface of the boiler assembly has a connection thread B, and the inner wall at the bottom of the upper lid has a connection thread A.

6. The multi-purpose capsule coffee pot according to claim 1, wherein the coffee bucket is provided with a bucket cover, and the boiler assembly is provided with a boiler assembly edge.

7. The multi-purpose capsule coffee pot according to claim 1, wherein the surface of the capsule container is provided with a shaped block, the surface of the block is provided with a plurality of fixed screw holes A, the surface of the capsule cartridge is provided with an O-shaped sealing ring, and the interior of the chamber is provided with a groove compatible with the shaped block.

8. The multi-purpose capsule coffee pot according to claim 1, wherein the bottom of the boiler assembly is provided with a bottom plate and the bottom plate is provided with laser welding.

9. The multipurpose capsule coffee pot according to claim 1, wherein the boiler assembly is fitted with one side of the surface, a temperature controller is fitted on one side of the connecting seat, and a fuse at the center of the inner wall of the connecting seat.

10. The multi-purpose capsule coffee pot according to claim 1, wherein the bottom of the base is provided, the storage assembly including a ring seat, the bottom of the mounting seat, the inner wall of the ring bump, the surface of the ring bump is bonded with a non-slip pad, the left and right sides of the bottom of the mounting seat are connected with a suction cup, the rotating member between the mounting seat and the base.
